(19) United States
(12) Patent Application Publication
(10) Pub. No.: US 2011/0246387 A1
(43) Pub. Date: Oct. 6, 2011

(54) CONSUMER BEHAVIOR MODIFICATION TOOL

(75) Inventors: Erik Stephen Ross, Charlotte, NC (US); Kathleen L. Dooley-Maley, Pineville, NC (US)

(73) Assignee: BANK OF AMERICA CORPORATION, CHARLOTTE, NC (US)

(21) Appl. No.: 12/751,335

(22) Filed: Mar. 31, 2010

(51) Int. Cl. G06Q 40/00

(52) U.S. Cl. 705/36 R; 235/379; 705/39

(57) ABSTRACT

Embodiments of the present invention relate to methods and apparatuses for implementing, in connection with a financial account, a consumer behavior modification tool. In some embodiments, the method includes: identifying a financial account that can be used by a consumer to make a purchase, recording in connection with the financial account a rule that additional liability in the form of a transaction fee or interest rate will be applied to the financial account when a purchase meeting predefined criteria is made using the financial account, wherein the predefined criteria is defined such that only a subset of the set of potential purchases that can be made using the financial account meet the predefined criteria, receiving an indication that a purchase has been made using the financial account, applying the rule to determine that the purchase that has been made meets the predefined criteria recorded in connection with the financial account, and investing the additional liability, in the form of a transaction fee or finance charge, into an investment vehicle.

### FIELD

In general terms, embodiments of the present invention relate to methods and apparatuses for implementing a consumer behavior modification tool, and in particular, embodiments of the present invention relate to methods and apparatuses for encouraging consumers to reduce spending on predefined types of goods or services in a manner that does not ultimately penalize them.

### BACKGROUND

Consumers today are often unable or unwilling to control their spending such that it aligns with their budget, or even with their means to pay. Even for those consumers having the best intentions of curbing unnecessary spending, the temptations in the marketplace can be too great to overcome. For example, consumers may intend to reduce spending on certain luxury purchases, such as retail coffee, restaurants, or unnecessary clothing or household goods, but are unable to stop making such purchases when they are confronted with the opportunity. According to various behavioral economic theories, there are a number of reasons for this. The first is the problem of hyperbolic discounting, whereby people attribute greater value to a reward that arrives sooner than a reward of equal or greater value that arrives later. Thus, consumers are driven by the impulsive belief that goods and services purchased today provide more value than the long-term savings and growth offered by investment of the amount of purchase. The second reason rests on the theory of inter-temporal tradeoffs, whereby people have extreme difficulty in comparing the utility of something today with the expected utility of a future payoff. Consumers cannot accurately compare the instant gratification associated with a purchase to the long-term benefit of investment. Finally, according to the theory of planning fallacy, people tend to underestimate what it takes to achieve a goal and consequently delay making efforts to reach the goal until closer to the deadline. Thus, consumers will underestimate what it will take to achieve their financial goals and do not begin saving or changing their spending behaviors when they should.

For the reasons stated above and other reasons, for many consumers, the price of the goods and services individually is not high enough to actually deter the consumers from making those purchases. Indeed, consumers can rationalize that they can afford to treat themselves to the goods and services they desire, and the costs associated with doing so, whether it is reduced savings or even incurring greater debt, is not enough to dissuade them. Unfortunately, these costs can have a grave effect on the financial health of the consumer. Consumers are struggling to save money for the future when spending the money now returns instant rewards in the form of goods and services. Furthermore, many consumers are deep in debt to credit card companies, lenders, etc., yet still are not taking active steps to pay off their debt by establishing more conservative and healthy spending practices because they are not adequately incentivized to cut spending.

In sum, it appears that while many consumers would like to reduce their spending in certain areas of the marketplace, when it comes to actually modifying their behavior and adopting new spending habits, the consumers fail because the benefits associated with that spending, i.e. the material goods or services obtained, outweigh the cost, i.e. the price of the goods or services as well as the lost savings or debt reduction opportunity. Accordingly, there is a need to provide methods and apparatuses that help consumers better manage their spending, and in particular, support consumers in modifying their spending behavior and adopting changes to reduce overall spending and increase savings and debt reduction.

### SUMMARY OF SELECTED EMBODIMENTS OF THE PRESENT INVENTION

In general terms, embodiments of the present invention relate to methods and apparatuses for encouraging consumers to reduce spending on predefined types of goods or services in a manner that does not ultimately penalize them. In particular, some embodiments of the present invention provide a computer-implemented method comprising: (1) identifying a financial account associated with a consumer, wherein the financial account can be used by the consumer to make a plurality of purchases, (2) recording in connection with the financial account a rule that additional liability will be applied to the financial account when a purchase meeting predefined criteria is made using the financial account, wherein the predefined criteria is defined such that only a subset of the plurality of purchases that can be made using the financial account meet the predefined criteria, (3) receiving an indication that a purchase has been made using the financial account, (4) applying the rule to determine that the purchase that has been made meets the predefined criteria recorded in connection with the financial account, and (5) investing an amount corresponding to the additional liability into an investment vehicle, wherein the amount is paid out of the financial account.

In some embodiments, the predefined criteria comprise a type of purchase, and the predefined criteria are selected by the consumer. In some embodiments, the predefined criteria comprise a purchase amount, and the predefined criteria are selected by the consumer. In some embodiments, the predefined criteria comprise a purchase made after a threshold amount is spent using the financial account on purchases of a particular type during a particular period. In some embodiments, the method further comprises analyzing historical data relating to past spending by the consumer and recommending to the consumer at least one of the predefined criteria, the additional liability, or the investment vehicle.

In some embodiments, the financial account is a credit card account. In some embodiments, the financial account is a checking account and the purchase is made using a debit card. In some embodiments, the investment vehicle comprises a savings account, a money market account, a mutual fund, a stock, or a bond. In some embodiments, the additional liability is a transaction fee and the amount corresponding to the additional liability is the transaction fee. In some embodiments, the additional liability is an interest rate and the amount corresponding to the additional liability is a finance charge. In some embodiments, the investment vehicle maintains the amount corresponding to the additional liability for the benefit of the consumer. In some embodiments, the investment vehicle maintains the amount corresponding to the additional liability for the benefit of a third party designated by the consumer. In some embodiments, the investment vehicle is selected by the consumer.

Some embodiments of the present invention provide a computer-implemented method comprising: (1) identifying a financial account associated with a consumer, wherein the financial account can be used by the consumer to make a plurality of purchases on credit and wherein a first interest rate is applied to overdue amounts owed by the consumer on the financial account, (2) recording in connection with the financial account a rule that a second interest rate will be applied to any overdue amount corresponding to a purchase meeting predefined criteria that is made using the financial account, wherein the predefined criteria is defined such that only a subset of the plurality of purchases that can be made using the financial account meet the predefined criteria, (3) receiving an indication that a purchase has been made using the financial account, (4) applying the rule to determine that the purchase that has been made meets the predefined criteria recorded in connection with the financial account, (5) receiving an overdue payment comprising a first portion corresponding to the purchase and the first interest rate and a second portion corresponding to the second interest rate, and (6) investing the second portion into an investment vehicle.

In some embodiments, the predefined criteria comprise a type of purchase, and the predefined criteria are selected by the consumer. In some embodiments, the predefined criteria comprise a purchase amount, and the predefined criteria are selected by the consumer. In some embodiments, the predefined criteria comprise a purchase made after a threshold amount is spent using the financial account on purchases of a particular type during a particular period. In some embodiments, the method further comprises analyzing historical data relating to past spending by the consumer and recommending to the consumer at least one of the predefined criteria, the additional liability, or the investment vehicle.

In some embodiments, the financial account is a credit card account. In some embodiments, the investment vehicle comprises a savings account, a money market account, a mutual fund, a stock, or a bond. In some embodiments, the investment vehicle maintains the transaction fee for the benefit of the consumer. In some embodiments, the investment vehicle maintains the transaction fee for the benefit of a third party designated by the consumer. In some embodiments, the investment vehicle is selected by the consumer.

Some embodiments of the present invention provide a system comprising an account datastore comprising information relating to a financial account that can be used by a consumer to make a plurality of purchases and a rule that additional liability will be applied to the financial account when a purchase meeting predefined criteria is made using the financial account, wherein the predefined criteria is defined such that only a subset of the plurality of purchases that can be made using the financial account meet the predefined criteria, and a processor configured to receive an indication that a purchase has been made using the financial account, apply the rule to determine that the purchase that has been made meets the predefined criteria recorded in connection with the financial account, and invest an amount corresponding to the additional liability into an investment vehicle, wherein the amount is paid out of the financial account.

In some embodiments, the processor is further configured to receive criteria information relating to the predefined criteria and the investment vehicle. In some embodiments, the criteria information is provided by the consumer. In some embodiments, the financial account comprises a checking account and the additional liability comprises a transaction fee. In some embodiments, the financial account comprises a credit card account, the additional liability comprises an interest rate, and the amount corresponding to the additional liability is a finance charge. In some embodiments, the investment vehicle maintains the amount corresponding to the additional liability for the benefit of the consumer. In some embodiments, the investment vehicle maintains the amount corresponding to the additional liability for the benefit of a third party designated by the consumer. In some embodiments, the investment vehicle is selected by the consumer.

Some embodiments of the present invention provide a computer program product comprising a computer-readable medium having computer-executable computer program code portions stored therein, wherein the computer-executable program code portions comprise: a first program code portion configured to identify a financial account associated with a consumer, wherein the financial account can be used by the consumer to make a purchase on credit and wherein a first interest rate is applied to overdue amounts owed by the consumer on the financial account, a second program code portion configured to record in connection with the financial account a rule that a second interest rate will be applied to any overdue amount corresponding to a purchase meeting predefined criteria that is made using the financial account, wherein the predefined criteria is defined such that only a subset of the set of potential purchases that can be made using the financial account meet the predefined criteria, a third program code portion configured to receive an indication that a purchase has been made using the financial account, a fourth program code portion configured to apply the rule to determine that the purchase that has been made meets the predefined criteria recorded in connection with the financial account, a fifth program code portion configured to receive an overdue payment comprising a first portion corresponding to the purchase and the first interest rate and a second portion corresponding to the second interest rate, and a sixth program code portion configured to invest the second portion into an investment vehicle.

### BRIEF DESCRIPTION OF THE DRAWINGS

Having thus described embodiments of the present invention in general terms, reference will now be made to the accompanying drawings, wherein:

FIG. 1 is a block diagram illustrating technical components of a system for implementing a consumer behavior modification tool, in accordance with an embodiment of the invention;

FIG. 2 is a flow diagram illustrating a method of enrolling a consumer into a consumer behavior modification program is provided, in accordance with an embodiment of the present invention;

FIG. 3 is a flow diagram illustrating a method of implementing a consumer behavior modification tool is provided, in accordance with an embodiment of the present invention; and

FIG. 4 is a flow diagram illustrating a method of implementing a consumer behavior modification tool is provided, in accordance with another embodiment of the present invention.

### DETAILED DESCRIPTION OF EMBODIMENTS OF THE PRESENT INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and/or vice versa, unless explicitly stated otherwise. Also, as used herein, the term “a” and/or “an” shall mean “one or more,” even though the phrase “one or more” is also used herein. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a non-transitory computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

Further, although many of the embodiments of the present invention described herein are generally described as involving a “financial institution,” other embodiments of the present invention may involve one or more persons, organizations, businesses, and/or other entities that take the place of, or work in conjunction with, the financial institution to implement one or more of the embodiments described herein as being performed by the financial institution.

In general terms, embodiments of the present invention relate to methods and apparatuses for implementing a consumer behavior modification tool in connection with a financial account held by a consumer and maintained by a financial institution. Embodiments of the present invention relate to applying a transaction fee and/or an additional interest rate to purchases made by the consumer using the financial account that meet predefined criteria selected by the consumer, and investing the resulting incurred transaction fees and finance charges into an investment vehicle held for the benefit of the consumer or a designee of the consumer. The transaction fee and/or finance charge acts as a deterrent to deter the consumer from engaging in certain behavior, specifically, making purchases meeting the selected criteria. However, because the transaction fees and finance charges are ultimately invested into the investment vehicle chosen by the consumer, the consumer is not completely penalized for the purchases.

For example, a consumer wanting to modify her behavior by spending less money at restaurants may enroll into a behavior modification program offered by the financial institution maintaining her financial account. During enrollment, the consumer can specify that she would like to incur a transaction fee and/or an additional finance charge in connection with purchases made at restaurants. The consumer can specify the particular transaction fee or interest rate or a method of calculating the transaction fee or interest rate. Finally, the consumer can specify the investment vehicle that will receive the transaction fees and finance charges attributable to the behavior modification tool. The investment vehicle may be an account held for the benefit of the consumer or a third party selected by the consumer. The financial institution, while processing a purchase involving the account, determines whether the purchase meets the criteria selected by the consumer during enrollment, i.e. whether the purchase was at a restaurant. If the criteria are met, the financial institution determines the applicable transaction fee and/or finance charge, applies the transaction fee and/or finance charge to the account, and invests the resulting transaction fee and/or finance charge in the investment vehicle chosen by the consumer during enrollment. Thus, the consumer is deterred from continuing to make restaurant purchases because she does not want to incur the additional liability of the transaction fee or the finance charge, however, even if the consumer does continue to make restaurant purchases, the ultimate result is beneficial for the consumer, as the money is merely relocated to an investment vehicle.

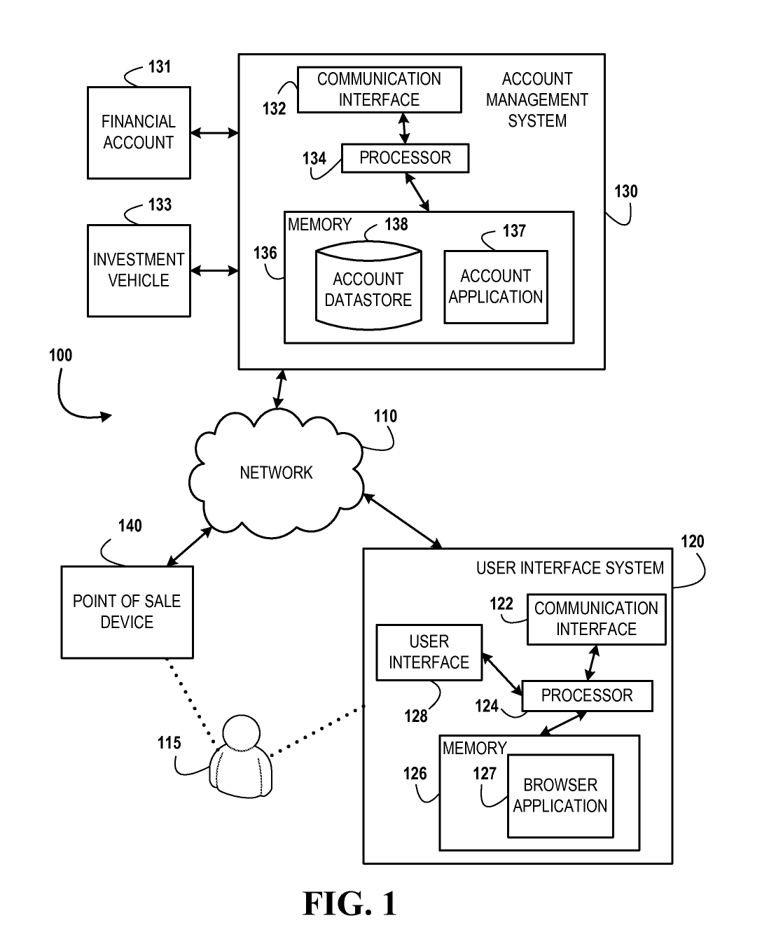

Referring now to FIG. 1, a system 100 for implementing a consumer behavior modification tool is provided, in accordance with an embodiment of the present invention. As illustrated, the system 100 includes a network 110, a user interface system 120, an account management system 130, and a point of sale device 140. FIG. 1 also illustrates a financial account 131 that can be used to pay for purchases (e.g., a credit card account, a checking account, etc.) and an investment vehicle 133 that can be used to invest money, which are operatively connected (e.g., communicably linked) to the account management system 130. Also shown in FIG. 1 is a consumer 115 that has access to the user interface system 120 and the point of sale device 140. In some embodiments, the financial account 131 is associated with the consumer 115 such that the consumer 115 may use the financial account 131 to pay for purchases. According to different embodiments, the investment vehicle 133 may be associated with the consumer 115, wherein the money is held in the account for the benefit of the consumer 115, or may be associated with another entity, for example, a particular entity designated by the consumer 115. In the illustrated embodiment, the user interface system 120 is maintained by the consumer 115, the point of sale device 140 is maintained by a merchant (not shown), and the account management system 130, along with the financial account 131 and the investment vehicle 133, are maintained by a financial institution (not shown). It will also be understood that the consumer 115 may use the financial account 131 to make one or more purchases from the merchant by using the point of sale device 140.

As shown in FIG. 1, the user interface system 120, the account management system 130, and the point of sale device 140 are each operatively and selectively connected to the network 110, which may include one or more separate networks. In addition, the network 110 may include a local area network (LAN), a wide area network (WAN), and/or a global area network (GAN), such as the Internet. It will also be understood that the network 110 may be secure and/or unsecure and may also include wireless and/or wireline technology.

The user interface system 120 may include any computerized apparatus that can be configured to perform any one or more of the functions of the user interface system 120 described and/or contemplated herein. In some embodiments, for example, the user interface system 120 may include a personal computer system, a mobile phone, a personal digital assistant, a public kiosk, a network device, and/or the like. As illustrated in FIG. 1, in accordance with some embodiments of the present invention, the user interface system 120 includes a communication interface 122, a processor 124, a memory 126 having a browser application 127 stored therein, and a user interface 128. In such embodiments, the communication interface 122 is operatively and selectively connected to the processor 124, which is operatively and selectively connected to the user interface 128 and the memory 126.

Each communication interface described herein, including the communication interface 122, generally includes hardware, and, in some instances, software, that enables a portion of the system 100, such as the user interface system 120, to transport, send, receive, and/or otherwise communicate information to and/or from the communication interface of one or more other portions of the system 100. For example, the communication interface 122 of the user interface system 120 may include a modem, server, electrical connection, and/or other electronic device that operatively connects the user interface system 120 to another electronic device, such as the electronic devices that make up the account management system 130.

Each processor described herein, including the processor 124, generally includes circuitry for implementing the audio, visual, and/or logic functions of that portion of the system 100. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the browser application 127 of the memory 126 of the user interface system 120.

Each memory device described herein, including the memory 126 for storing the browser application 127 and other data, may include any non-transitory computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more pieces of information and data used by the system in which it resides to implement the functions of that system.

As shown in FIG. 1, the memory 126 includes the browser application 127. In some embodiments, the browser application 127 includes a web browser and/or some other application for communicating with, navigating, controlling, configuring, and/or using the account management system 130 and/or other portions of the system 100. For example, in some embodiments, the consumer 115 uses the browser application 127 to trigger and/or configure one or more aspects of the account management system 130 that relate to implementing the consumer behavior modification tool of embodiments of the present invention. As another example, in some embodiments, the consumer 115 uses the browser application 127 to enroll in or activate a program whereby additional liability will be assigned to the financial account 131, for example, in the form of additional interest or a transaction fee, in the event purchases of a particular type defined by the consumer 115 during enrollment are made using the financial account 131 (discussed in more detail below). As another example, in some embodiments, the consumer 115 uses the browser application 127 to review the transaction history associated with the financial account 131, and in particular, whether any additional transaction fee or additional interest has been applied. As another example, in some embodiments, the consumer 115 uses the browser application 127 to make a payment on the financial account 131, for example, where the financial account 131 is a credit card account. As yet another embodiment, in some embodiments, the consumer 115 uses the browser application to view and manage the investment vehicle 133. In some embodiments, the consumer 115 uses the browser application 127 to access an online and/or mobile banking account (not shown) for configuring these one or more aspects of the account management system 130. In some embodiments, the user interface system 120 is a mobile device and the consumer 115 is able to enroll in the program using the mobile device. In some embodiments, the browser application 127 includes computer-executable program code portions for instructing the processor 124 to perform one or more of the functions of the browser application 127 described and/or contemplated herein. In some embodiments, the browser application 127 may include and/or use one or more network and/or system communication protocols.

Also shown in FIG. 1 is the user interface 128. In some embodiments, the user interface 128 includes one or more user output devices, such as a display and/or speaker, for presenting information to the consumer 115 and/or some other user. In some embodiments, the user interface 128 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the consumer 115 and/or some other user. In some embodiments, the user interface 128 includes the input and display devices of a personal computer, such as a keyboard and monitor, that are operable to receive and display information associated with offsetting a liability and/or accumulating rewards.

FIG. 1 also illustrates an account management system 130, in accordance with an embodiment of the present invention. The account management system 130 may include any computerized apparatus that can be configured to perform any one or more of the functions of the account management system 130 described and/or contemplated herein. In accordance with some embodiments, for example, the account management system 130 may include a computer network, an engine, a platform, a server, a database system, a front end system, a back end system, a personal computer system, and/or the like. In some embodiments, such as the one illustrated in FIG. 1, the account management system 130 includes a communication interface 132, a processor 134, and a memory 136, which includes an account application 137 and an account datastore 138 stored therein. As shown, the communication interface 132 is operatively and selectively connected to the processor 134, which is operatively and selectively connected to the memory 136.

It will be understood that the account application 137 can be configured to implement any one or more portions of any one or more of the methods described below and/or otherwise contemplated herein. For example, in some embodiments, the account application 137 may be operable to process financial transactions involving the financial account 131 and/or the investment vehicle 133. For example, where the consumer 115 attempts to make a purchase with the credit account 131 at the point of sale device 140, the account application 137 may be configured to approve a payment request from the point of sale device 140. As another example, in some embodiments, the account application 137 is configured to utilize the communication interface 132 to provide online and/or mobile banking services to the consumer 115 via the network 110 at the user interface system 120, such as, for example, any of the online and/or mobile banking services described and/or contemplated herein, including services with respect to the financial account 131 and the investment vehicle 133.

It will also be understood that, in some embodiments, the account application 137 is configured to communicate with the account datastore 138, the user interface system 120, the point of sale device 140, and/or any one or more other portions of the system 100. For example, in some embodiments, the account application 137 is configured to send payment authorization information to, and/or receive transaction data from, the point of sale device 140. As another example, in some embodiments, the account application 137 is configured to create and/or send one or more notifications to the consumer 115 at the user interface system 120 that explain, for example, that a payment is due or that a transaction fee or additional interest has been assessed on the financial account 131 and/or applied to the investment vehicle 133. It will be further understood that, in some embodiments, the account application 137 includes computer-executable program code portions for instructing the processor 134 to perform any one or more of the functions of the account application 137 described and/or contemplated herein. In some embodiments, the account application 137 may include and/or use one or more network and/or system communication protocols.

In some embodiments, the account application 137 may be configured to utilize the communication interface 132 to receive information associated with the financial account 131 in any way and/or in any form. In some embodiments, the account management system 130 is configured to utilize the account application 137 to manage the financial account 131 for the consumer 115 by, for example, opening the financial account 131 for the consumer 115, providing online and/or mobile services associated with the accounts (e.g., online and/or mobile banking, etc.), processing and/or posting transactions and purchases involving the financial account 131, calculating the account balance for the financial account 131, calculating the minimum payment due for the financial account 131, calculating any interest due on the account and any transaction fees applicable to particular transactions and purchases, setting the payment due date for the financial account 131, communicating account statements to the account holder, receiving a deposit into the financial account 131 from the account holder, receiving a payment on the financial account 131 from the account holder, and/or the like.

In addition to the account application 137, the memory 136 also includes the account datastore 138. In some embodiments, the account datastore 138 includes information associated with the financial account 131 and the investment vehicle 133, including, for example, account names, persons and/or entities associated with the financial accounts, addresses associated with the financial account 131, transaction data and/or transaction history associated with the financial account 131, whether one or more financial accounts are linked to the financial account 131, and/or any other type and/or amount of information. In some embodiments, the account datastore 138 may also store any information relating to implementing a behavior modification tool as described herein. In some embodiments, the account datastore 138 stores information associated with online and/or mobile banking.

It will be understood that the account datastore 138 may include any one or more storage devices, including, but not limited to, datastores, databases, and/or any of the other storage devices typically associated with a computer system. It will also be understood that the account datastore 138 may store information in any known way, such as, for example, by using one or more computer codes and/or languages, alphanumeric character strings, data sets, figures, tables, charts, links, documents, and/or the like. Further, in some embodiments, the account datastore 138 may include information associated with one or more applications, such as, for example, the account application 137. It will also be understood that, in some embodiments, the account datastore 138 provides a substantially real-time representation of the information stored therein, so that, for example, when the processor 134 accesses the account datastore 138, the information stored therein is current or substantially current. It will be understood that the embodiment illustrated in FIG. 1 is exemplary and that other embodiments may vary. For example, in some embodiments, the account management system 130 includes more, less, or different components, such as, for example, an account manager (e.g., financial institution employee) user interface.

It will be understood that the financial account 131 may be and/or include any type of account that can be used to make purchases. In one embodiment, the financial account 131 is a credit card account. In another embodiment, the financial account 131 is a checking account. In other embodiments, the financial account 131 is a non-traditional financial account, such as, for example, a retailer account. Also, it will be understood that, although much of the description herein refers to accounts held by individuals, the financial account 131 may be held by one or more families, households, social networks, businesses (e.g., corporations, business units within corporations, small businesses, for profit organizations, non-profit organizations, etc.), and/or other entities. For example, in some embodiments, the account management system 130 is configured to implement a consumer behavior modification tool for a family, rather than a single consumer. In such embodiments, the financial account 131 may be the family checking account or family credit card account, where the account is jointly held by husband and wife. As another example, in some embodiments, the system is configured to implement a consumer behavior modification tool for a business, and the financial account 131 is a business checking account or a business LOC account.

Additionally, it will be understood that, in some embodiments, the financial account 131 includes two or more accounts. In other words, in some embodiments, the account management system 130 is configured to implement a consumer behavior modification tool for two or more financial accounts associated with the consumer 115. For example, in some embodiments, the account management system 100 is configured to implement a consumer behavior modification tool for both a checking account and a credit card account, such that additional liability is applied to each account for particular transactions made using the accounts. In some embodiments, both of these accounts are owned, controlled, serviced, managed, operated, and/or maintained (collectively referred to herein as “maintained” for simplicity) by a single financial institution.

According to some embodiments, the investment vehicle 133 is any type of account or investment into which money may be invested or stored, for example, stocks, mutual funds, bonds, money market accounts, retirement accounts, savings accounts, college accounts, checking accounts, etc. In other embodiments, the investment vehicle 133 is not a traditional savings or investment account, but an investment that is valuable for reasons other than savings or growth, for example, social or personal reasons. Thus, according to some embodiments, the investment vehicle 133 is an account associated with a charity or small business. In other embodiments, the investment vehicle 133 is a debt account such as a loan, mortgage, or HELOC account, or some other outstanding financial obligation. In such embodiments, the debt account or obligation does not necessarily belong to the consumer 115, but may belong to a third party, including a charity, and the consumer desires to contribute to paying it off. Generally, and as described in greater detail below, the investment vehicle 133 can include any account or entity that is designated by the consumer 115 to receive monies in accordance with embodiments of the present invention. In some embodiments, the investment vehicle 133 may include two or more different investments or accounts. For example, in one embodiment, the investment vehicle 133 may include a money market account and an IRA.

It should be understood that, in some embodiments, some or all of the portions of the system 100 may be combined into a single portion. Specifically, in some embodiments, the user interface system 120 and the account management system 130 are combined into a single user interface and account management system configured to perform all of the same functions of those separate portions as described and/or contemplated herein. Likewise, in some embodiments, some or all of the portions of the system 100 may be separated into two or more distinct portions. Specifically, in some embodiments, the account management system 130 may be separated into a financial account datastore system configured to store and/or manage transaction data and a behavior modification system configured to credit and debit accounts, apply transaction fees and additional interest to accounts, and communicate with the account holder. In addition, the various portions of the system 100 may be maintained for by the same or separate parties. For example, as previously mentioned, a single financial institution may maintain the financial account 131, the investment vehicle 133, and the account management system 130. However, in other embodiments, the financial account 131, the investment vehicle 133, and/or the account management system 130 may each be maintained by separate entities.

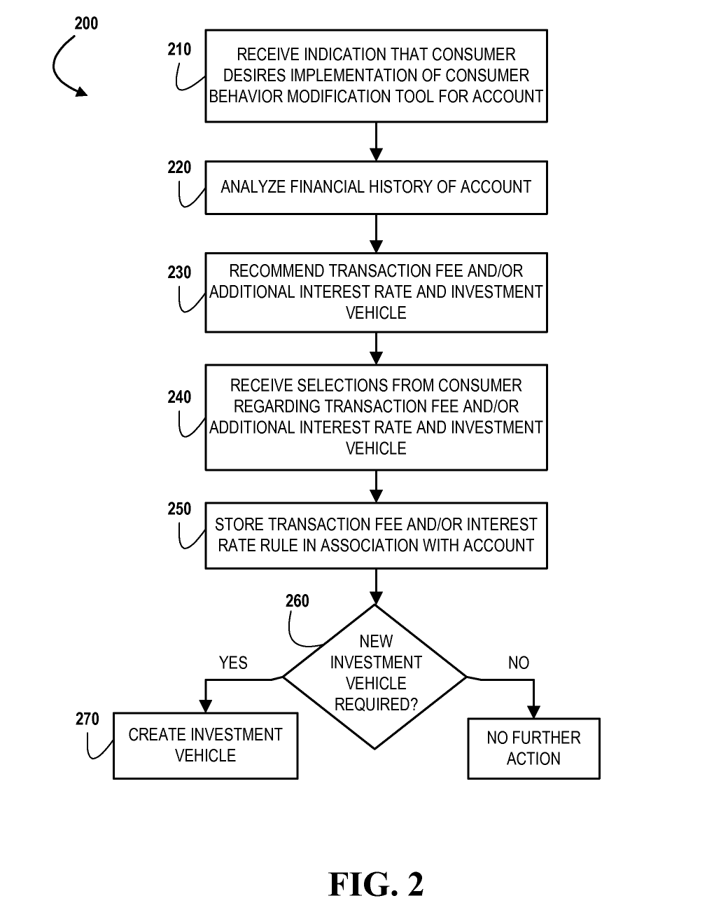

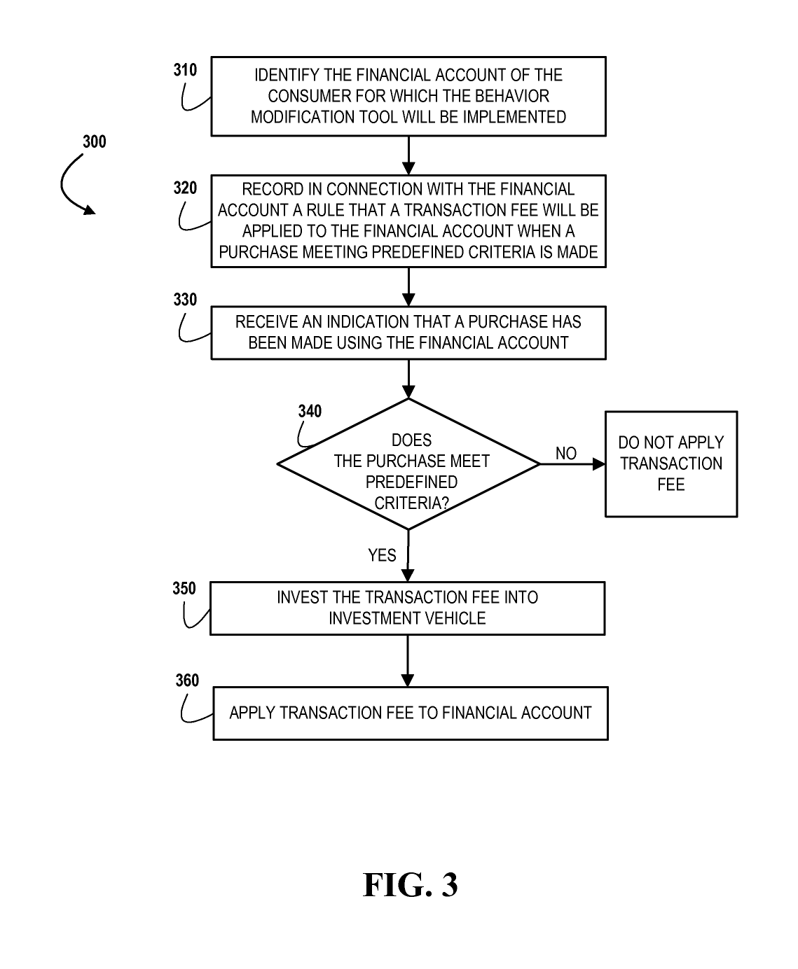

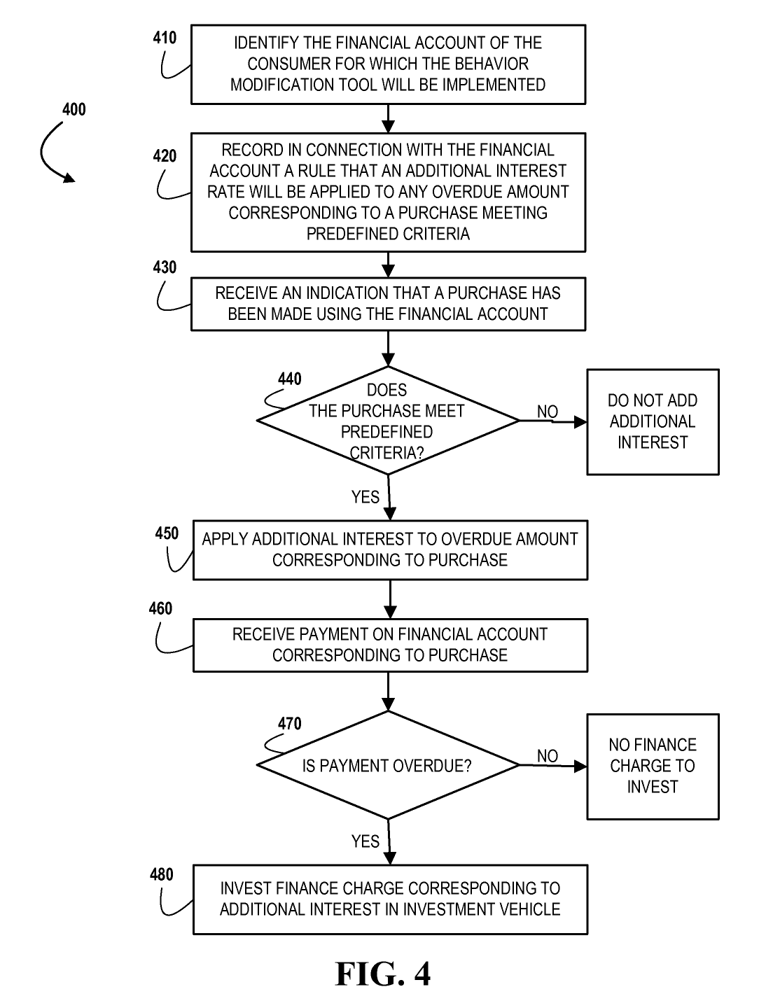

It will also be understood that the system 100 may include and/or implement any embodiment of the present invention described and/or contemplated herein. For example, in some embodiments, the system 100 is configured to implement any one or more of the embodiments of the method 200 described and/or contemplated herein in connection with FIG. 2, any one or more of the embodiments of the method 300 described and/or contemplated herein in connection with FIG. 3, and any one or more of the embodiments of the method 400 described and/or contemplated herein in connection with FIG. 4.

Referring now to FIG. 2, a method 200 of enrolling a consumer into a consumer behavior modification program is provided, in accordance with an embodiment of the present invention. As represented by the block 210, the consumer 115 provides an indication to the account management system 130 that the consumer 115 desires the account management system 130 to implement a consumer behavior modification tool in connection with a financial account maintained by the financial institution for the benefit of the consumer 115. For example, the consumer 115 requests that the financial institution implement a consumer behavior modification tool in connection with the financial account 131. In some embodiments, the consumer 115 may use the user interface system 120 to communicate the request to the account management system 130 through an online banking system. In other embodiments, the consumer 115 may make the request in person, via electronic mail, via telephone, or otherwise.

As represented by the block 220, the financial institution analyzes the financial history of the financial account 131. In particular, the account management system 130 may utilize the account application 137 to review the history of the financial account 131 and determine spending patterns and transaction trends. In some embodiments, the history and the results of the analysis may be transmitted to the user interface system 120 by the account management system 130 and displayed to the consumer 115 via the user interface 128. In other embodiments, the analysis may be presented in person, for example, by a representative of the financial institution. According to some embodiments, the analysis provided to the consumer 115 includes a detailed report of the transactions engaged in by the consumer 115 over a particular period, broken down by type of transaction, for example, clothing, groceries, restaurants, healthcare, utilities, etc., and amount. Such information can aid the consumer 115 in identifying any habitual spending that is problematic or unnecessary. By viewing a detailed analysis of exactly how the consumer 115 has been spending money using the financial account 131, the consumer 115 is in a better position to determine types of purchases where the consumer 115 has exceeded a predefined budget or otherwise desires to cut back spending. In some embodiments, the financial history analysis provided by the account management system 130 is optional and the consumer 115 may opt in or opt out of receiving it. In other embodiments, it is not provided at all. Consumers that are already aware of their spending habits and the areas in which they would like to curb spending may have less need for the analysis.

As represented by the block 230, the account management system 130 provides a recommendation of the transaction fee or additional interest to be applied to certain purchases made by the consumer 115, as well as the investment vehicle in which to invest the transaction fee or finance charges received from the consumer 115. In some embodiments, the account management system 120 may present numerous options to the consumer 115 as to how the behavior modification tool may be implemented, for example, the types of purchases to which it may be applied, the types of deterrent that may be utilized, for example, transaction fee or additional interest, the amount of deterrent used, i.e. the amount of transaction fee or additional interest, and the types of investment vehicles available to the consumer 115 for investing the additional payments corresponding to the deterrent. Thus, according to some embodiments, the account management system 130 may receive input from the consumer 115 in response to the options. For example, a consumer may wish to stop spending so much money on restaurants, and might indicate to the account management system 130 that she wishes that the penalty for spending money at restaurants be high to deter that behavior. The consumer may also indicate whether she would prefer a transaction fee or additional interest applied to such purchases and how she would like her additional payment invested. The account management system 130, taking into account the input of the consumer 115, may then use the account application 137 to provide a recommendation to the consumer 115 of the particular specifications of the behavior modification tool that will be implemented with the financial account 131.

As represented by the block 240, the consumer 115 communicates to the account management system 130 the selections that will determine how the behavior modification tool is implemented. In particular, the consumer 115 selects what type of purchases the tool will be applied to, whether a transaction fee or additional interest on overdue amounts will apply (this may be partially determined by the type of financial account inasmuch as certain accounts such as checking account do not lend themselves to finance charges), how much the transaction fee or additional interest will be (may be a predefined amount or a method of calculation based on the underlying purchase), and how the consumer's payments corresponding to the transaction fees and additional interest will be invested. In some embodiments, the consumer 115 may select from options presented by the account management system 130 and in other embodiments, the consumer 115 may originate all of the indications without being presented options. In some embodiments, the consumer 115 uses the user interface system 120 to communicate the selections via an online banking system operated by the account management system 130. As represented by the block 250, the account management system 130 stores the selections made by the consumer in connection with the financial account 131 as a rule that when purchases of the type selected by the consumer 110 occur, the transaction fee and/or additional interest selected by the consumer will be applied to the financial account 131, and the additional payment corresponding to the transaction fee and/or additional interest is invested into the investment vehicle selected by the consumer.

As represented by the block 260, depending on whether the consumer 115 has selected an already-existing account as the investment vehicle 133, the account management system 130 may need to create the investment vehicle 133 for the consumer 115 or establish connectivity with the investment vehicle 133 such that the account management system 130 can transfer money to the investment vehicle when the rule stored in connection with the financial account 131 is triggered. If, for example, the consumer 115 selected an existing retirement account or money market account or other investment account that is maintained by the financial institution, then no new investment vehicle would need to be created. If, on the other hand, the consumer 115 desires the additional payments corresponding to the transaction fees and finance charges attributable to the additional interest to be invested in a new mutual fund account, then, as represented by the block 270, a new investment vehicle will need to be created. In addition, according to some embodiments, the account management system 130 must establish an interface with the selected investment vehicle such that money may be transferred to it. The interface information should be stored with the rule in connection with the financial account 131.

Referring now to FIG. 3, a method 300 of implementing a consumer behavior modification tool is provided, in accordance with one embodiment of the present invention. As represented by the block 310, the account management system 130 first identifies the financial account associated with the consumer 115 for which the consumer behavior modification tool will be limited, i.e. the financial account 131. As discussed above with reference to FIG. 2, in some embodiments, the consumer 115 enrolls into a program to receive the services of the behavior modification tool, and during that enrollment process provides to the account management system 130 information regarding the financial account 131, among other information.

Next, as represented by the block 320, the account management system 130 records in connection with the identified financial account 131 a rule that a transaction fee will be applied to the financial account 131 when a purchase meeting predefined criteria is made using the financial account 131. As discussed above with reference to FIG. 2, in some embodiments, the rule is recorded based on selections made by the consumer 115, whether through an online banking system utilizing the user interface system 120 or otherwise. Thus, in some embodiments, the consumer 115 selects the predefined criteria that will trigger a transaction fee on purchases, such as type of purchase and/or the amount of the purchase. The consumer 115 may also select the amount of the transaction fee that will be applied, if it is selected to be a fixed amount, or the method of calculation of the transaction fee, if it selected to by dependent upon the amount of the purchase. All of the foregoing information is recorded in connection with the financial account 131 as part of the rule. According to some embodiments, the predefined criteria is defined such that only a subset of the set of potential purchases that can be made using the financial account 131 meet the predefined criteria. Thus, according to some embodiments, the rule recorded in connection with the financial account 131 will not be structured such that each and every potential purchase made using the financial account 131 will incur the defined transaction fee, and rather only a subset of potential purchases will give rise to the transaction fee.

According to some embodiments, the predefined criteria selected by the consumer may include purchases of a particular type, purchases with a particular vendor, purchases of a particular type or with a particular vendor over a certain amount, purchases of a particular type or with a particular vendor after a particular amount has already been spent in a particular time period, or a combination of the foregoing. For example, the consumer 115 may select the predefined criteria to be all purchases of food and drink at restaurants. As another example, the consumer 115 may select the predefined criteria to be all purchases made at a particular retailer. As another example, the consumer 115 may select the predefined criteria to be all purchases made at a particular retailer that are greater than a threshold amount. As another example, the consumer 115 may select the predefined criteria to be all purchases made at a particular retailer, but only after the consumer 115 has already spent a threshold amount at the retailer during the preceding month. It should be understood that the predefined criteria may take any form such that the predefined criteria will only apply to a subset of the set of potential purchases that may be made using the financial account 131.

As represented by the block 330, the account management system 130 receives an indication that a purchase has been made using the financial account 131. In particular, in some embodiments, the point of sale device 130 communicates via the network 110 to the account management system 130 that a purchase has been made that affects the financial account 131 associated with the consumer 115. Next, as represented by the block 340, the account management system 130 makes a determination as to whether the purchase meets the predefined criteria recorded in connection with the financial account 131. In particular, in some embodiments, the account application 137 applies the rule recorded in connection with the financial account 131 to the information received from the point of sale device 140 and determines whether the type of purchase and/or amount of the purchase was selected by the consumer 115 during enrollment as the type of purchase and/or amount of purchase that triggers application of a transaction fee. If the account application 137, determines that the purchase does not meet the predefined criteria, the transaction fee is not applied. On the other hand, if the account application 137 determines that the purchase does meet the predefined criteria, as represented by the block 350, the transaction fee is invested into an investment vehicle.

In some embodiments, the account management system 130 is configured to process the purchase by debiting the financial account 131 associated with the consumer 115 when it receives indication of the purchase from the point of sale device 140, for example, when the financial account 131 is a checking account and the purchase is made using a debit card. In such embodiments, at approximately or exactly the same time as the account management system 130 is processing the purchase by debiting the financial account 131, the account management system 130 can apply the rule to determine the amount of the transaction fee, and debit the financial account 131 in the amount of the transaction fee, transferring that money to the investment vehicle 133 selected by the consumer 115 during enrollment. In other embodiments, the account management system 130 is configured to process the purchase by adding liability to the financial account 131 to be paid at a later time by the consumer 115, for example, when the financial account 131 is a credit card account. In such embodiments, the account management system 130 may be configured to invest the transaction fee prior to receiving payment for the transaction fee from the consumer 115 by adding additional liability to the financial account 131 corresponding to the transaction fee. Thus, in some embodiments, the transaction fee is applied to the financial account 131 such that the transaction fee is paid out of the account.

Referring now to FIG. 4, a method 400 of implementing a consumer behavior modification tool is provided, in accordance with one embodiment of the present invention. As represented by the block 410, the account management system 130 first identifies the financial account associated with the consumer 115 for which the consumer behavior modification tool will be limited, i.e. the financial account 131. According to some embodiments, the financial account is a credit card account having a predefined interest rate that is applied to any overdue balance on the account. This interest rate may be referred to for convenience as the first interest rate. As represented by the block 420, the account management system 130 records in connection with the identified financial account 131 a rule that an additional interest rate will be applied to any overdue amounts in the financial account 131 that correspond to a purchase meeting predefined criteria. This additional interest rate may be referred to for convenience as the second interest rate.

As represented by the block 430, the account management system 130 receives an indication that a purchase has been made using the financial account 131. Next, as represented by the block 440, the account management system 130 determines whether the purchase meets the predefined criteria recorded in connection with the financial account 131. In the event the purchase does meet the predefined criteria, as represented by the block 450, the account management system 130 utilizes the recorded rule to determine and/or calculate the second interest rate and resulting finance charge that applies to the amount of the purchase in the financial account 131. This calculated interest rate and/or finance charge may be communicated to the consumer 115, for example, via an online banking system or a bank statement. As represented by the block 460, a payment is received by the account management system 130 corresponding to the purchase. In some embodiments, as represented by the block 470, the account management system 130 determines if the payment is overdue, i.e. whether the balance of the financial account 131 has been paid in full. In the event the payment is overdue, then, as represented by the block 480, the second interest rate is applied to the overdue amount and the resulting finance charge is invested into the investment vehicle selected by the consumer 115 during enrollment. It should be understood that, in other embodiments, the second interest rate will be applied to the amount of the purchase in the financial account 131 whether or not the payment is overdue. Thus, even if the consumer 115 pays the balance when due, the consumer 115 pays a finance charge attributable to the second interest rate.

In some embodiments, the consumer 115 may suspend or terminate her enrollment in the consumer behavior modification tool for the financial account 131 at any time. For example, in some embodiments, the consumer 115 may use the user interface system 120 to communicate the request for suspension or termination to the account management system 130 through an online banking system. In other embodiments, the consumer 115 may make the request for suspension or termination in person, via electronic mail, via telephone, or otherwise. According to some embodiments, the account management system 130 is configured to suspend the consumer behavior modification tool or otherwise prevent the transaction fee or additional interest from being applied to the financial account 131 when a purchase meeting the predefined criteria is made in the event application of the transaction fee or additional interest would exceed the balance or credit limit of the financial account 131 or otherwise impose a financial hardship on the consumer 115.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A computer-implemented method comprising:
identifying a financial account associated with a consumer, wherein the financial account can be used by the consumer to make a plurality of purchases;
recording in connection with the financial account a rule that additional liability will be applied to the financial account when a purchase meeting predefined criteria is made using the financial account, wherein the predefined criteria is defined such that only a subset of the plurality of purchases that can be made using the financial account meet the predefined criteria;
receiving an indication that a purchase has been made using the financial account;
applying the rule to determine that the purchase that has been made meets the predefined criteria recorded in connection with the financial account; and
investing an amount corresponding to the additional liability into an investment vehicle, wherein the amount is paid out of the financial account.

2. The method of claim 1, wherein the predefined criteria comprise a type of purchase, and wherein the predefined criteria are selected by the consumer.

3. The method of claim 1, wherein the predefined criteria comprise a purchase amount, and wherein the predefined criteria are selected by the consumer.

4. The method of claim 1, wherein the predefined criteria comprise a purchase made after a threshold amount is spent using the financial account on purchases of a particular type during a particular period.

5. The method of claim 1, further comprising:
analyzing historical data relating to past spending by the consumer; and
recommending to the consumer at least one of the predefined criteria, the additional liability, or the investment vehicle.

6. The method of claim 1, wherein the financial account is a credit card account.

7. The method of claim 1, wherein the financial account is a checking account and the purchase is made using a debit card.

8. The method of claim 1, wherein the investment vehicle comprises a savings account, a money market account, a mutual fund, a stock, or a bond.

9. The method of claim 1, wherein the additional liability is a transaction fee and the amount corresponding to the additional liability is the transaction fee.

10. The method of claim 1, wherein the additional liability is an interest rate and the amount corresponding to the additional liability is a finance charge.

11. The method of claim 1, wherein the investment vehicle maintains the amount corresponding to the additional liability for the benefit of the consumer.

12. The method of claim 1, wherein the investment vehicle maintains the amount corresponding to the additional liability for the benefit of a third party designated by the consumer.

13. The method of claim 1, wherein the investment vehicle is selected by the consumer.

14. A computer-implemented method comprising:
identifying a financial account associated with a consumer, wherein the financial account can be used by the consumer to make a plurality of purchases on credit and wherein a first interest rate is applied to overdue amounts owed by the consumer on the financial account;
recording in connection with the financial account a rule that a second interest rate will be applied to any overdue amount corresponding to a purchase meeting predefined criteria that is made using the financial account, wherein the predefined criteria is defined such that only a subset of the plurality of purchases that can be made using the financial account meet the predefined criteria;
receiving an indication that a purchase has been made using the financial account;
applying the rule to determine that the purchase that has been made meets the predefined criteria recorded in connection with the financial account;
receiving an overdue payment comprising a first portion corresponding to the purchase and the first interest rate and a second portion corresponding to the second interest rate; and
investing the second portion into an investment vehicle.

15. The method of claim 14, wherein the predefined criteria comprise a type of purchase, and wherein the predefined criteria are selected by the consumer.

16. The method of claim 14, wherein the predefined criteria comprise a purchase amount, and wherein the predefined criteria are selected by the consumer.

17. The method of claim 14, wherein the predefined criteria comprise a purchase made after a threshold amount is spent using the financial account on purchases of a particular type during a particular period.

18. The method of claim 14, further comprising:
analyzing historical data relating to past spending by the consumer; and
recommending to the consumer at least one of the predefined criteria, the additional liability, or the investment vehicle.

19. The method of claim 14, wherein the financial account is a credit card account.

20. The method of claim 14, wherein the investment vehicle comprises a savings account, a money market account, a mutual fund, a stock, or a bond.

21. The method of claim 14, wherein the investment vehicle maintains the transaction fee for the benefit of the consumer.

22. The method of claim 14, wherein the investment vehicle maintains the transaction fee for the benefit of a third party designated by the consumer.

23. The method of claim 14, wherein the investment vehicle is selected by the consumer.

24. A system comprising:
an account datastore comprising information relating to a financial account that can be used by a consumer to make a plurality of purchases and a rule that additional liability will be applied to the financial account when a purchase meeting predefined criteria is made using the financial account, wherein the predefined criteria is defined such that only a subset of the plurality of purchases that can be made using the financial account meet the predefined criteria; and
a processor configured to:
receive an indication that a purchase has been made using the financial account;
apply the rule to determine that the purchase that has been made meets the predefined criteria recorded in connection with the financial account; and
invest an amount corresponding to the additional liability into an investment vehicle, wherein the amount is paid out of the financial account.

25. The system of claim 24, wherein the processor is further configured to:
receive criteria information relating to the predefined criteria and the investment vehicle.

26. The system of claim 25, wherein the criteria information is provided by the consumer.

27. The system of claim 24, wherein the financial account comprises a checking account and the additional liability comprises a transaction fee.

28. The system of claim 24, wherein the financial account comprises a credit card account, the additional liability comprises an interest rate, and the amount corresponding to the additional liability is a finance charge.

29. The system of claim 24, wherein the investment vehicle maintains the amount corresponding to the additional liability for the benefit of the consumer.

30. The system of claim 24, wherein the investment vehicle maintains the amount corresponding to the additional liability for the benefit of a third party designated by the consumer.

31. The system of claim 24, wherein the investment vehicle is selected by the consumer.

32. A computer program product comprising a computer-readable medium having computer-executable computer program code portions stored therein, wherein the computer-executable program code portions comprise:
a first program code portion configured to identify a financial account associated with a consumer, wherein the financial account can be used by the consumer to make a purchase on credit and wherein a first interest rate is applied to overdue amounts owed by the consumer on the financial account;
a second program code portion configured to record in connection with the financial account a rule that a second interest rate will be applied to any overdue amount corresponding to a purchase meeting predefined criteria that is made using the financial account, wherein the predefined criteria is defined such that only a subset of the set of potential purchases that can be made using the financial account meet the predefined criteria;
a third program code portion configured to receive an indication that a purchase has been made using the financial account;
a fourth program code portion configured to apply the rule to determine that the purchase that has been made meets the predefined criteria recorded in connection with the financial account;
a fifth program code portion configured to receive an overdue payment comprising a first portion corresponding to the purchase and the first interest rate and a second portion corresponding to the second interest rate; and
a sixth program code portion configured to invest the second portion into an investment vehicle.
